(19) United States
(12) Patent Application Publication
(10) Pub. No.: US 2024/0264293 A1
(43) Pub. Date: Aug. 8, 2024

(54) CONTROL DEVICE AND CONTROL METHOD

(71) Applicant: Panasonic Intellectual Property Management Co., Ltd., Osaka (JP)

(72) Inventors: Kazumi SEKIGUCHI, Kanagawa (JP); Hisayoshi EBINA, Kanagawa (JP); Ryo ITO, Aichi (JP)

(21) Appl. No.: 18/407,036

(22) Filed: Jan. 8, 2024

(30) Foreign Application Priority Data
Feb. 7, 2023 (JP) 2023-016891

(51) Int. Cl. G01S 7/52; G01S 15/931

(52) U.S. Cl. CPC G01S 7/52004; G01S 15/931; G01S 2007/52009

(57) ABSTRACT

A control device according to the present disclosure includes an acquisition circuit, and a determination circuit. The acquisition circuit acquires a wave width of an ultrasonic wave transmitted by an ultrasonic sensor. The determination circuit determines that a resonance has occurred when the wave width of the ultrasonic wave acquired by the acquisition circuit is smaller than a threshold.

### CROSS-REFERENCE TO RELATED APPLICATIONS

This application is based upon and claims the benefit of priority from Japanese Patent Application No. 2023-016891, filed on Feb. 7, 2023, the entire contents of which are incorporated herein by reference.

### FIELD

The present disclosure relates to a control device and a control method.

### BACKGROUND

Existing techniques for detecting objects such as preceding vehicles, obstacles, or pedestrians by distance measuring sensors such as ultrasonic sensors mounted on vehicles are known. In addition, techniques for performing various types of control for improving traveling safety of vehicles, for example, operation of automatic brakes, notification to drivers, and the like based on object detection results by distance measuring sensors are known.

A related technique is disclosed in JP 2018-081050 A.

However, in the existing techniques, it is difficult to correctly discriminate between unnecessary resonance of an ultrasonic sensor and reflected sound from an obstacle. For example, it has been difficult to correctly discriminate between resonance generated due to an adhering substance to an ultrasonic sensor, temperature fluctuation, variation in the ultrasonic sensor itself, or the like, and reflected sound from an obstacle.

The present disclosure provides a control device capable of correctly discriminating unnecessary resonance of an ultrasonic sensor and reflected sound from an obstacle.

### SUMMARY

A control device according to the present disclosure includes an acquisition circuit, and a determination circuit. The acquisition circuit acquires a wave width of an ultrasonic wave transmitted by an ultrasonic sensor. The determination circuit determines that a resonance has occurred when the wave width of the ultrasonic wave acquired by the acquisition circuit is smaller than a threshold.

### BRIEF DESCRIPTION OF THE DRAWINGS

FIG. 1 is a diagram illustrating an example of a configuration of a detection system according to an embodiment;

FIG. 2 is a diagram illustrating an example of a configuration of a measurement unit according to an embodiment;

FIG. 3 is a diagram for explaining resonance and reflected sound of an obstacle;

FIG. 4 is a diagram for explaining a threshold used for determination of unnecessary resonance and an obstacle;

FIG. 5 is a diagram for explaining a threshold used for determination of unnecessary resonance and an obstacle;

FIG. 6 is a diagram for explaining a threshold used for determination of unnecessary resonance and an obstacle;

FIG. 7 is a flowchart illustrating an example of a flow of determination processing according to an embodiment;

FIG. 8 is a diagram illustrating an example of a configuration of a measurement unit according to an embodiment;

FIG. 9 is a diagram illustrating an example of detection of a short-distance object according to an embodiment;

FIG. 10 is a diagram illustrating an example of detection of foreign matter adhesion according to an embodiment;

FIG. 11 is a flowchart illustrating an example of a flow of determination processing according to an embodiment; and

FIG. 12 is a diagram illustrating an example of a hardware configuration of a control device according to an embodiment.

### DETAILED DESCRIPTION

Hereinafter, embodiments of a detection system according to the present disclosure will be described with reference to the drawings. Note that, in the following, examples in which a detection system 1 is mounted on a vehicle will be described, but the present disclosure is not limited thereto.

### 1. First Embodiment

### 1-1. Configuration Example of Detection System

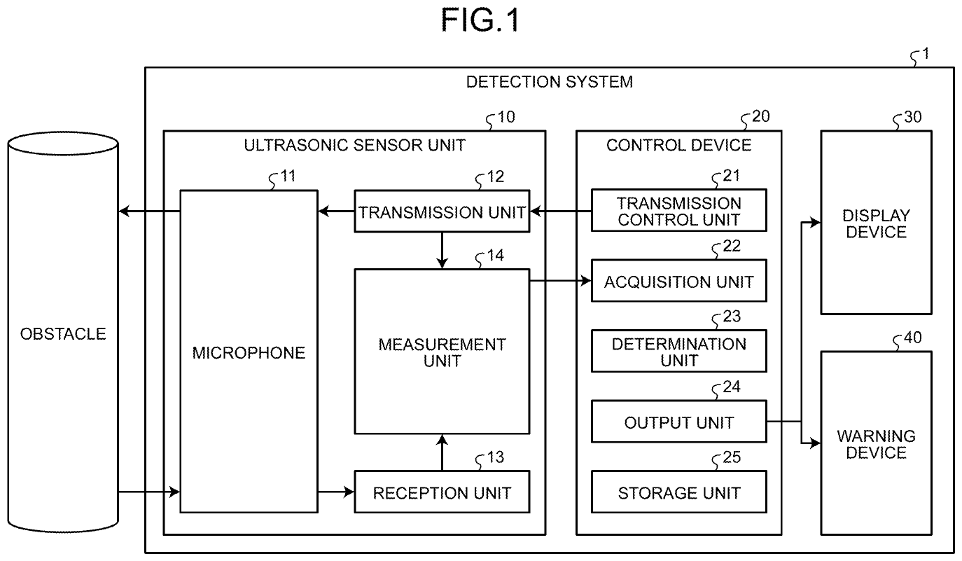

As illustrated in FIG. 1, the detection system 1 includes an ultrasonic sensor 10, a control device 20, a display device 30, and a warning device 40. In the present embodiment, the detection system 1 includes the ultrasonic sensor 10, the control device 20, the display device 30, and the warning device 40. Note that other parts may be mounted on the detection system 1.

Further, in FIG. 1, the ultrasonic sensor 10, the control device 20, the display device 30, and the warning device 40 are illustrated as separate parts, but some or all of these parts may be integrated. The ultrasonic sensor 10 includes a microphone 11, a transmission unit 12, a reception unit 13, and a measurement unit 14.

The transmission unit 12 causes the microphone 11 to transmit an ultrasonic wave. For example, the transmission unit 12 receives a signal from a transmission control unit 21 and causes the microphone 11 to transmit an ultrasonic wave.

The microphone 11 transmits and receives an ultrasonic wave. For example, the microphone 11 receives a signal from the transmission unit 12, transmits an ultrasonic wave, and receives reflected sound of the ultrasonic wave colliding with an object.

The reception unit 13 receives reflected sound of an ultrasonic wave. For example, the reception unit 13 receives the reflected sound of the ultrasonic wave received by the microphone 11 and converts the reflected sound into an electric signal.

The measurement unit 14 acquires the wave width of the reflected sound of the ultrasonic wave based on the electric signal for transmitting the ultrasonic wave to the microphone 11 received from the transmission unit 12 and the electric signal of the reflected sound of the ultrasonic wave received from the reception unit 13.

The control device 20 includes the transmission control unit 21, an acquisition unit 22, a determination unit 23, an output unit 24, and a storage unit 25. Hereinafter, each unit included in the control device 20 will be described.

The transmission control unit 21 transmits an electric signal to the transmission unit 12 and controls transmission of an ultrasonic wave by the microphone 11.

The acquisition unit 22 acquires a wave width of the ultrasonic wave transmitted by the ultrasonic sensor. In addition, the acquisition unit 22 acquires the reverberation end time of the ultrasonic wave transmitted by the ultrasonic sensor. For example, the acquisition unit 22 acquires the wave width of the ultrasonic wave transmitted by the ultrasonic sensor and the reverberation end time of the ultrasonic wave from the measurement unit 14 described later.

Here, the reverberation end time refers to a time from when an electric signal for transmitting an ultrasonic wave is transmitted from the transmission unit 12 to the microphone 11 to be described later until the electric signal converted by the reception unit 13 becomes smaller than a predetermined threshold. Note that the reverberation end time is not limited thereto, and may be a time from when the vibration of the microphone 11 ends until the electric signal converted by the reception unit 13 becomes smaller than a predetermined threshold.

In a case where the wave width of the ultrasonic wave acquired by the acquisition unit 22 is smaller than the threshold, the determination unit 23 determines that the resonance has occurred. For example, in a case where the wave width of the ultrasonic wave acquired by the acquisition unit 22 is less than a value of ⅖ of the reverberation time, the determination unit 23 determines that the resonance has occurred.

As a specific example, since the wave width “100 μs” of the ultrasonic wave acquired by the acquisition unit 22 is less than a value “680 μs” that is ⅖ of the reverberation time “1700 μs”, the determination unit 23 determines that the resonance has occurred. Furthermore, for example, the determination unit 23 determines that it is not resonance since the wave width “700 μs” of the ultrasonic wave acquired by the acquisition unit 22 is equal to or more than a value “680 μs” that is ⅖ of the reverberation time “1700 μs”.

The output unit 24 outputs the result determined by the determination unit 23 to an external device such as the display device 30 or the warning device 40. For example, in a case where the determination unit 23 determines that resonance of the ultrasonic sensor 10 has occurred, the output unit 24 causes the display device 30 to display a message notifying that resonance has occurred in the ultrasonic sensor 10. Note that, in a case where the determination unit 23 determines that the resonance of the ultrasonic sensor 10 has occurred, the detection system 1 may stop the detection processing by the detection system 1.

In addition, for example, in a case where the determination unit 23 detects an obstacle, the output unit 24 causes the display device 30 to display a message notifying that there is an obstacle. In addition, for example, in a case where the determination unit 23 detects an obstacle, the output unit 24 causes the warning device 40 to output a warning notifying that there is an object.

The storage unit 25 stores a value used for determination performed by the determination unit 23. For example, the storage unit 25 stores the wave width, the reverberation end time, and the wave width threshold. For example, the storage unit 25 stores values such as a wave width “170 μs”, a reverberation end time “1700 μs”, and a wave width threshold “⅖ of reverberation time”. Note that the stored value is an example, and the value is not limited thereto.

The display device 30 receives the output from the output unit 24 and displays contents based on the detection result determined by the determination unit 23. For example, in a case where the determination unit 23 determines that resonance has occurred, the display device 30 receives an output from the output unit 24 and displays a message notifying occurrence of resonance on a monitor portion mounted in the vehicle. At this time, the display device 30 may also display a message notifying that the detection processing by the detection system 1 is stopped.

The warning device 40 receives the output from the output unit 24 and issues an alarm based on the detection result determined by the determination unit 23. For example, in a case where it is determined by the determination unit 23 that there is an obstacle, the warning device 40 may output a warning sound such as “beep” and output a warning in response to the output from the output unit 24. In addition, for example, in a case where the determination unit 23 determines that resonance has occurred, the warning device 40 may output a warning sound such as “peep” and output a warning in response to the output from the output unit 24. Note that the warning device 40 can emit a warning sound corresponding to the output from the output unit 24 or the content to be notified to the operator.

### 1-2. Configuration of Measurement Unit

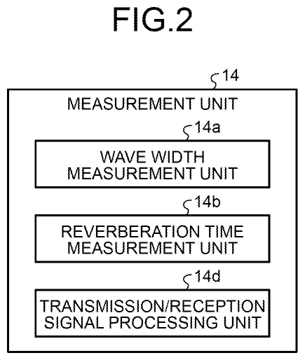

Next, the measurement unit 14 of the control device 100 according to the first embodiment will be described with reference to FIG. 2. As illustrated in FIG. 2, the measurement unit 14 of the present embodiment includes a wave width measurement unit 14a, a reverberation time measurement unit 14b, and a transmission/reception signal processing unit 14d. Hereinafter, each unit included in the measurement unit 14 will be described.

The wave width measurement unit 14a measures the wave width of the ultrasonic wave based on an electric signal for transmitting the ultrasonic wave to the microphone 11 from the transmission unit 12 and an electric signal of reverberation and reflected sound of the ultrasonic wave from the reception unit 13. For example, the wave width measurement unit 14a measures the wave width by measuring the time from when the value indicated by the electric signal converted by the reception unit 13 starts rising to when it ends falling. Note that, the wave width measurement unit 14a can use a predetermined threshold or a predetermined variation of a value to determine whether the value indicated by the electric signal converted by the reception unit 13 starts rising or ends falling at the time of measuring the wave width.

The reverberation time measurement unit 14b measures the reverberation end time based on an electric signal for transmitting an ultrasonic wave to the microphone 11 from the transmission unit 12 and an electric signal of reverberation of the ultrasonic wave from the reception unit 13. For example, the reverberation time measurement unit 14b measures the reverberation end time by measuring the time until the electric signal converted by the reception unit 13 becomes smaller than a predetermined threshold after the electric signal transmitted from the transmission unit 12 to the microphone 11 and transmitting the ultrasonic wave to the microphone 11 is transmitted.

The transmission/reception signal processing unit 14d receives and processes electrical signals from the transmission unit 12 and the reception unit 13. For example, the transmission/reception signal processing unit 14d receives electrical signals from the transmission unit 12 and the reception unit 13, and processes the electrical signals so that the wave width measurement unit 14a and the reverberation time measurement unit 14b can perform measurement.

### 1-3. Detection of Resonance

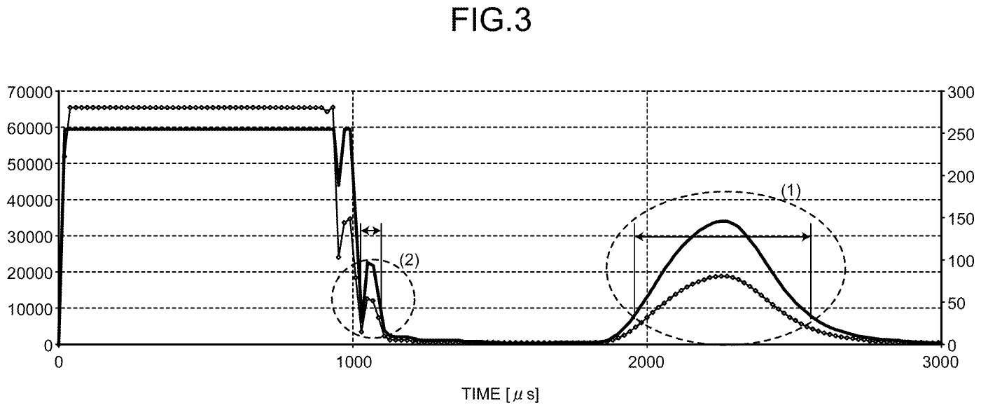

Next, detection of resonance by the detection system 1 according to the embodiment will be described with reference to FIGS. 3 to 6. In the following example, the detection system 1 is mounted on a vehicle, and the detection system 1 detects resonance of the ultrasonic sensor 10.

First, the transmission control unit 21 transmits an electric signal for transmitting an ultrasonic wave to the microphone 11 via the transmission unit 12. Next, the microphone 11 receives an electric signal and transmits an ultrasonic wave.

Next, the microphone 11 receives the reflected sound of the ultrasonic wave colliding with the obstacle and transmits the reflected sound to the reception unit 13. Next, the reception unit 13 converts the reverberation and the reflected sound of the ultrasonic wave into an electric signal. Next, the transmission/reception signal processing unit 14d receives the electrical signal from the transmission unit 12 and the reception unit 13, and processes the electrical signal so that the electrical signal can be handled by the wave width measurement unit 14a. In this way, the wave width measurement unit 14a and the reverberation time measurement unit 14b receive the electrical signal processed by the transmission/reception signal processing unit 14d and measure the wave width.

Here, FIG. 3 is a diagram illustrating a waveform when an ultrasonic wave is transmitted from the ultrasonic sensor 10. As illustrated in (1) of FIG. 3, in a case where an obstacle is present, reflected sound that has hit the obstacle is measured as a large wave width.

On the other hand, a small wave width (unnecessary resonance) is generated between the transmission of the ultrasonic wave and the reverberation end time as illustrated in (2) of FIG. 3 due to a temperature change, an adhering substance to the ultrasonic sensor 10, a variation in the ultrasonic sensor 10, and the like.

Subsequently, the acquisition unit 22 acquires the wave width from the wave width measurement unit 14a and the reverberation end time from the reverberation time measurement unit 14b. Subsequently, the determination unit 23 makes a determination based on the wave width and the reverberation end time acquired by the acquisition unit 22.

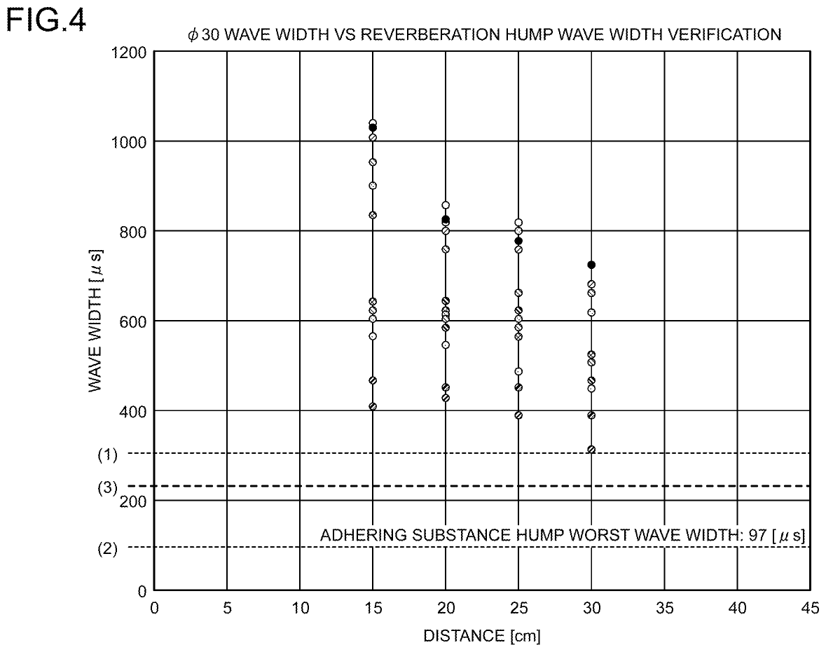

Next, a threshold used to determine unnecessary resonance and an obstacle will be described with reference to FIG. 4. FIG. 4 is a diagram in which a parallel width obtained by unnecessary resonance and a wave width obtained by reflected sound of an obstacle are plotted for each distance to the obstacle. The determination unit 23 can use a predetermined threshold to determine unnecessary resonance and reflected sound of an obstacle based on the wave width. For example, a region above (1) of FIG. 4 is a region of a wave width obtained by reflected sound of an obstacle, and a region below (2) of FIG. 4 is a region of a wave width obtained by unnecessary resonance. Therefore, as illustrated in (3) of FIG. 4, the determination unit 23 uses a determination threshold that can determine unnecessary resonance and reflected sound of an obstacle.

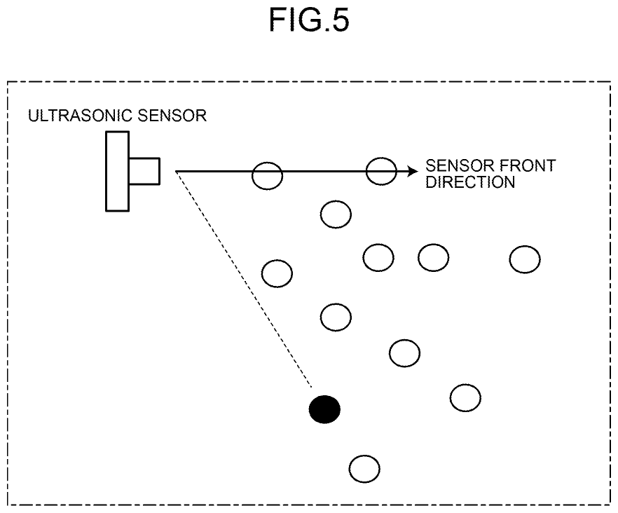

Note that, as illustrated in FIG. 5, the threshold used when the determination unit 23 determines unnecessary resonance and reflected sound of an obstacle by a wave is a value obtained by an experiment of transmitting an ultrasonic wave to the obstacle arranged at various distances and angles. According to this experiment, it has been found that it is possible to determine unnecessary resonance and reflected sound of an obstacle depending on whether or not the wave width is smaller than a value of ⅖ of the reverberation end time.

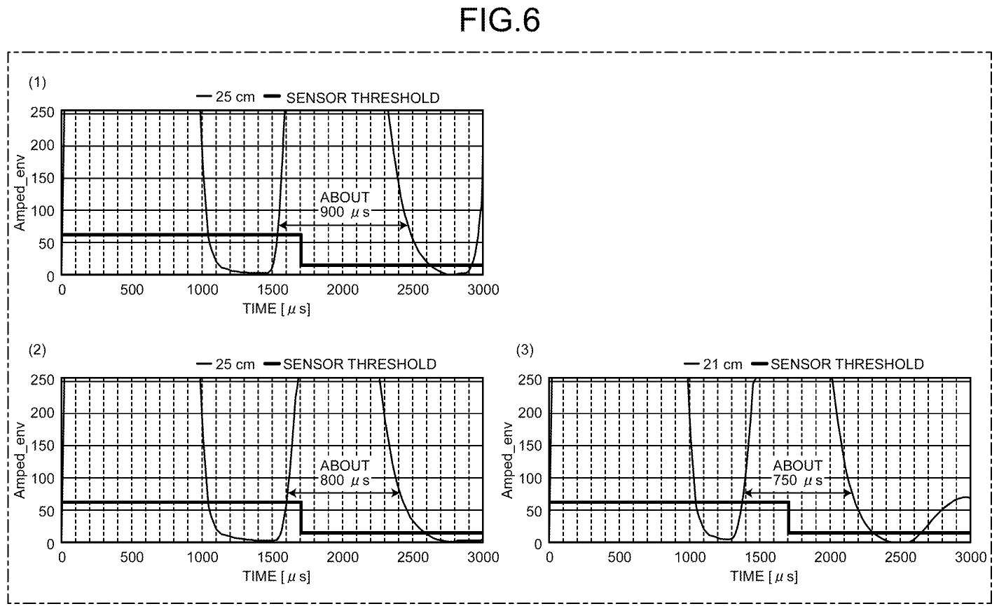

Note that, as illustrated in FIG. 6, the wave width of the ultrasonic wave changes depending on the size of the obstacle. For example, in a case where the obstacle is a facing wall, a wave width of about 900 μs is obtained as illustrated in (1) of FIG. 6, but in a case where the obstacle is a pole having a diameter of 100 mm, a wave width of about 800 μs is obtained as illustrated in (2) of FIG. 6, and in a case where the obstacle is a pole having a diameter of 30 mm, a wave width of about 750 μs is obtained as illustrated in (3) of FIG. 6.

Then, the determination unit 23 makes a determination using a threshold obtained by an experiment. For example, in a case where the wave width of the ultrasonic wave acquired by the acquisition unit 22 is smaller than a value of ⅖ of the reverberation end time, the determination unit 23 determines that the resonance has occurred. On the other hand, in a case where the wave width of the ultrasonic wave acquired by the acquisition unit 22 is larger than the value of ⅖ of the reverberation end time, the determination unit 23 determines that it is the reflected sound of the obstacle.

### 1-4. Flowchart

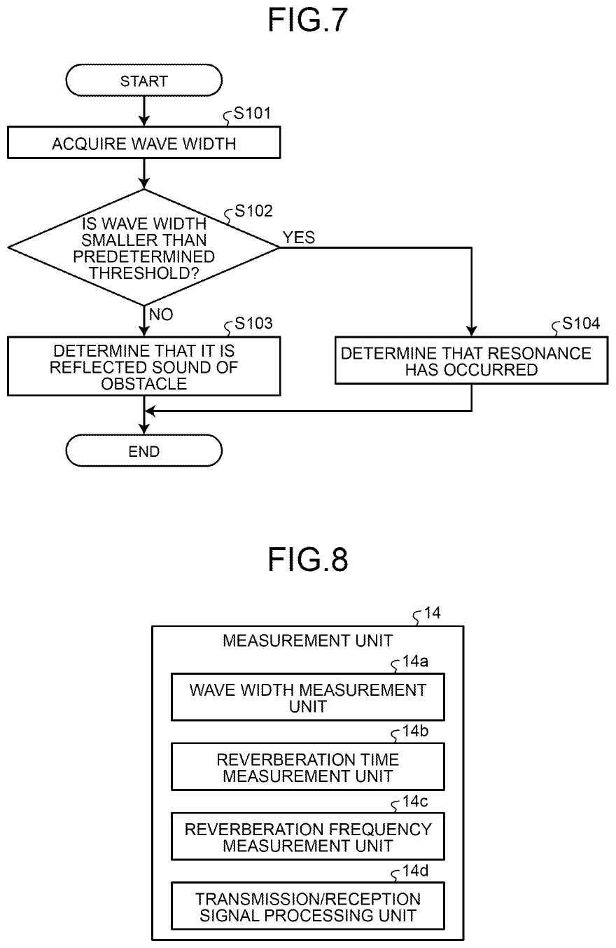

Next, a flow of detection processing executed by the detection system 1 configured as described above will be described with reference to FIG. 7. Note that the following steps can be executed in different orders, and there may be omitted processing.

First, the acquisition unit 22 acquires a wave width of an ultrasonic wave transmitted by the ultrasonic sensor 10 (step S101). For example, the acquisition unit 22 acquires the wave width of the ultrasonic wave transmitted by the ultrasonic sensor 10 from the measurement unit 14.

Subsequently, the determination unit 23 determines whether or not the acquired wave width of the ultrasonic wave is smaller than a threshold (step S102). At this time, in a case where the wave width of the acquired ultrasonic wave is not smaller than the threshold (step S102 “No”), the determination unit 23 determines that it is reflected sound of an obstacle (step S103).

On the other hand, in a case where the acquired wave width of the ultrasonic wave is smaller than the threshold (“Yes” in step S102), it is determined that resonance of the ultrasonic sensor 10 has occurred (S104).

### 1-5. Effects

As described above, the control device 20 according to the embodiment includes the acquisition unit 22 that acquires the wave width of the ultrasonic wave transmitted by the ultrasonic sensor 10, and the determination unit 23 that determines that the resonance has occurred in a case where the wave width of the ultrasonic wave acquired by the acquisition unit 22 is smaller than the threshold.

As a result, the control device 20 according to the embodiment can correctly discriminate unnecessary resonance of the ultrasonic sensor 10 and reflected sound from an obstacle by determining the wave width of the ultrasonic wave using the threshold.

In addition, the acquisition unit 22 in the control device 20 according to the embodiment acquires the wave width of the ultrasonic wave transmitted by the ultrasonic sensor 10 provided on the front, rear, or side surface of the vehicle. As a result, the control device 20 according to the embodiment can correctly discriminate the unnecessary resonance of the ultrasonic sensor and the reflected sound from the obstacle by determining the wave width of the ultrasonic wave transmitted by the ultrasonic sensor provided on the front, rear, or side surface of the vehicle using the threshold.

Furthermore, the determination unit 23 in the control device 20 according to the embodiment uses a value of ⅖ of the reverberation end time as the threshold. As a result, the control device 20 according to the embodiment can correctly discriminate the unnecessary resonance of the ultrasonic sensor 10 and the reflected sound from the obstacle by using the threshold of ⅖ of the reverberation end time as the parallel width of the ultrasonic wave.

### 2. Second Embodiment

Although the first embodiment has been described above, the second embodiment will be described below. Note that description similar to that of the first embodiment will be omitted as appropriate. In the second embodiment, the control device 100 further uses information on the reverberation time and the reverberation frequency to discriminate whether foreign matter adheres or an obstacle existing in the vicinity of the ultrasonic sensor 10 is present. Note that the reverberation frequency refers to a frequency during a time from when the vibration of the microphone 11 ends until the electric signal converted by the reception unit 13 becomes smaller than a predetermined threshold.

### 2-1. Configuration Example of Detection System

Next, a configuration of the control device 100 will be described with reference to FIG. 1. Hereinafter, each unit included in the control device 100 will be described, but description of processing similar to that of the first embodiment will be omitted.

The acquisition unit 22 further acquires the reverberation end time and the reverberation frequency. For example, the acquisition unit 22 acquires the reverberation end time and the reverberation frequency from the measurement unit 14.

Based on the reverberation end time and the reverberation frequency acquired from the acquisition unit 22, the determination unit 23 determines whether a foreign matter is attached to the ultrasonic sensor 10 or whether or not a short-distance object exists in the vicinity of the ultrasonic sensor 10. For example, the determination unit 23 determines whether the reverberation end time of the ultrasonic wave is longer than a predetermined threshold. As a result, in a case where the reverberation end time is longer than the predetermined threshold, the determination unit 23 determines whether the difference between the reverberation frequency and the natural frequency of the microphone 11 is within a predetermined range. On the other hand, in a case where the reverberation end time of the ultrasonic sound is shorter than the predetermined threshold, the determination unit 23 performs the processing described in the first embodiment.

Furthermore, in a case where the difference between the natural frequency and the reverberation frequency of the microphone 11 is within a predetermined range, the determination unit 23 determines that there is a short-distance object. At this time, in a case where the difference between the natural frequency and the reverberation frequency of the microphone 11 exceeds a predetermined range, the determination unit 23 determines that a foreign matter is attached to the ultrasonic sensor 10. Furthermore, for example, the determination unit 23 determines whether the reverberation end time of the ultrasonic wave is shorter than a predetermined threshold. At this time, in a case where the reverberation end time is shorter than a predetermined threshold, the determination unit 23 determines that thin ice is present in the ultrasonic sensor 10.

As a specific example, a case where the acquisition unit 22 acquires “2100 μs” as the reverberation end time and “54950 Hz” as the reverberation frequency, and the natural frequency of the microphone 11 is “55000 Hz” will be described. First, the determination unit 23 determines that the reverberation end time 2100 μs acquired from the acquisition unit 22 is longer than the threshold of 1700 μs. Then, the determination unit 23 determines that the difference between the natural frequency 55000 Hz of the microphone 11 and the reverberation frequency 54950 Hz is within ±0.1% of the natural frequency 55000 Hz of the microphone 11. In this manner, the determination unit 23 determines that there is a short-distance object in the vicinity of the ultrasonic sensor 10.

Note that the threshold is not limited thereto. Furthermore, based on the reverberation characteristics such as the reverberation end time and the reverberation frequency, the determination unit 23 can detect the state of the ultrasonic sensor 10, such as adhesion of foreign matter to the ultrasonic sensor 10 and thin ice on the ultrasonic sensor 10, in addition to the short-distance object existing in the vicinity of the ultrasonic sensor 10.

The output unit 24 outputs the result determined by the determination unit 23 to an external device such as the display device 30 or the warning device 40. For example, in a case where the determination unit 23 detects adhesion of foreign matter to the ultrasonic sensor 10, the output unit 24 causes the display device 30 to display a message notifying that foreign matter adheres to the ultrasonic sensor 10. Furthermore, for example, in a case where the determination unit 23 detects a short-distance object, the output unit 24 causes the display device 30 to display a message notifying that there is a short-distance object. Furthermore, for example, in a case where the determination unit 23 detects a short-distance object, the output unit 24 causes the warning device 40 to output a warning notifying that there is a short-distance object.

Next, the storage unit 25 stores a value used for determination performed by the determination unit 23. For example, the storage unit 25 stores “1700 μs” and “800 μs” as the thresholds of the reverberation end time, and “55000 Hz” as the natural frequency of the microphone 11. Note that the stored value is an example, and the value is not limited thereto.

Next, the display device 30 receives the output from the output unit 24 and displays contents based on the detection result determined by the determination unit 23. For example, in a case where the determination unit 23 determines that a foreign matter is attached to the ultrasonic sensor 10, the display device 30 receives an output from the output unit 24 and displays a message notifying a detection result of the adhesion of the foreign matter on a monitor portion mounted in the vehicle. Furthermore, for example, in a case where the determination unit 23 determines that there is a short-distance object, the display device 30 displays a message notifying a detection result of the short-distance object on a monitor portion mounted in the vehicle.

Then, the warning device 40 receives the output from the output unit 24 and issues an alarm based on the detection result determined by the determination unit 23. For example, in a case where it is determined by the determination unit 23 that there is a short-distance object, the warning device 40 receives the output from the output unit 24, emits a warning sound of “beep”, and outputs a warning.

### 2-2. Configuration of Measurement Unit

Next, the measurement unit 14 of the control device 100 according to the second embodiment will be described with reference to FIG. 8. The measurement unit 14 of the control device 100 according to the second embodiment is different from the measurement unit 14 illustrated in FIG. 2 in further including a reverberation frequency measurement unit 14c.

As illustrated in FIG. 8, the measurement unit 14 of the second embodiment includes a wave width measurement unit 14a, a reverberation time measurement unit 14b, a reverberation frequency measurement unit 14c, and a transmission/reception signal processing unit 14d. Hereinafter, each unit included in the measurement unit 14 will be described. Note that description similar to that of the first embodiment will be omitted as appropriate.

The reverberation frequency measurement unit 14c measures the reverberation frequency based on the electric signal from the reception unit 13. For example, the reverberation frequency measurement unit 14c measures the reverberation frequency by measuring the frequency during the reverberation time measured by the reverberation time measurement unit 14b.

The transmission/reception signal processing unit 14d receives and processes electrical signals from the transmission unit 12 and the reception unit 13. For example, the transmission/reception signal processing unit 14d receives electrical signals from the transmission unit 12 and the reception unit 13, and processes the electrical signals so that the wave width measurement unit 14a, the reverberation time measurement unit 14b, and the reverberation frequency measurement unit 14c can perform measurement.

### 2-3. Detection of Short-Distance Object

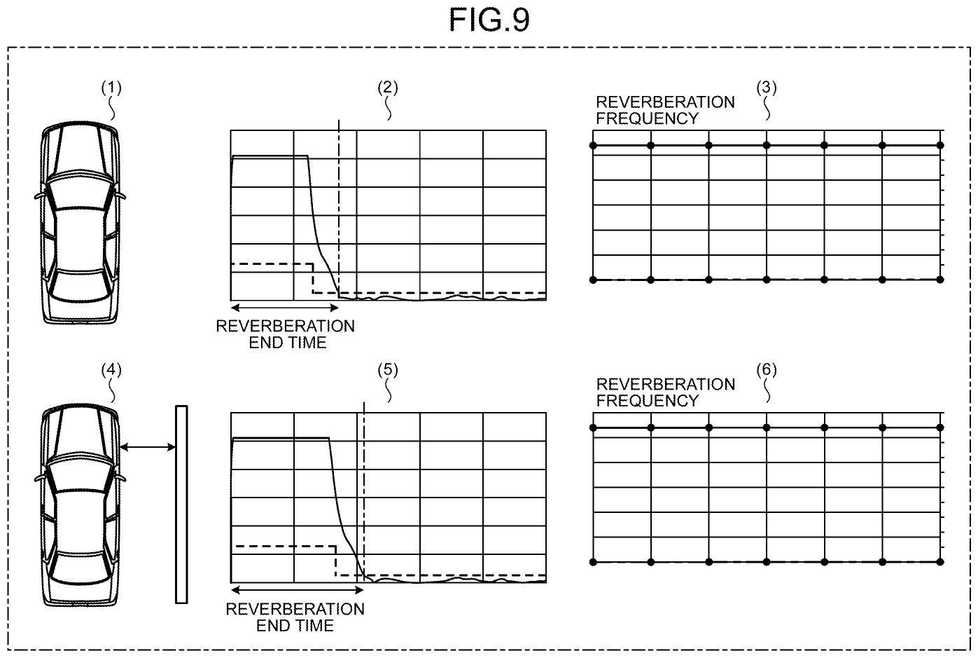

Next, detection of a short-distance object according to the embodiment will be described with reference to FIG. 9. In the following example, the detection system 1 is mounted on a vehicle, and the detection system 1 detects a short-distance object existing in the vicinity of the ultrasonic sensor 10. First, the transmission control unit 21 transmits an electric signal for transmitting an ultrasonic wave to the microphone 11 via the transmission unit 12. Next, the microphone 11 receives an electric signal and transmits an ultrasonic wave.

Next, the microphone 11 receives the reverberation generated when the ultrasonic wave is transmitted and the reflected sound of the ultrasonic wave hitting the wall, and transmits the reverberation and the reflected sound to the reception unit 13. Next, the reception unit 13 converts reverberation and reflected sound caused by transmission of an ultrasonic wave into an electric signal. Next, the transmission/reception signal processing unit 14d receives the electrical signal from the transmission unit 12 and the reception unit 13, and processes the electrical signal so that the electrical signal can be handled by the reverberation time measurement unit 14b and the reverberation frequency measurement unit 14c.

In this way, the reverberation time measurement unit 14b receives the electrical signal processed by the transmission/reception signal processing unit 14d and measures the time when reverberation ends. Furthermore, the reverberation frequency measurement unit 14c receives the electrical signal processed by the transmission/reception signal processing unit 14d and measures the reverberation frequency.

At this time, as illustrated in (1) of FIG. 9, in a case where there is no short-distance object in the vicinity of the vehicle on which the detection system 1 is mounted, as illustrated in (2) of FIG. 9, the reverberation end time is not affected by the reflected sound from the short-distance object. On the other hand, as illustrated in (4) of FIG. 9, in the case that a wall exists in the vicinity of the vehicle on which the detection system 1 is mounted, as illustrated in (5) of FIG. 9, the reverberation end time becomes long because the reverberation generated by the transmission of the ultrasonic wave overlaps with the reflected sound in which the ultrasonic wave collides with the wall that is the short-distance object existing in the vicinity of the vehicle.

Furthermore, as illustrated in (1) of FIG. 9, in a case where there is no short-distance object in the vicinity of the vehicle on which the detection system 1 is mounted, as illustrated in (3) of FIG. 9, the reverberation frequency hardly fluctuates with respect to the natural frequency of the microphone 11. Furthermore, as illustrated in (4) of FIG. 9, in a case where a wall exists in the vicinity of the vehicle on which the detection system 1 is mounted, as illustrated in (6) of FIG. 9, the reverberation frequency hardly fluctuates with respect to the natural frequency of the microphone 11.

Next, the acquisition unit 22 acquires the reverberation end time from the reverberation time measurement unit 14b and the reverberation frequency from the reverberation frequency measurement unit 14c. Next, the determination unit 23 makes a determination based on the reverberation end time and the reverberation frequency acquired by the acquisition unit 22. As a specific example, a case where the acquisition unit 22 acquires “2100 μs” as the reverberation end time and “54950 Hz” as the reverberation frequency, and the natural frequency of the microphone 11 is “55000 Hz” will be described. First, the determination unit 23 determines that the reverberation end time 2100 μs acquired by the acquisition unit 22 is longer than the threshold 1700 μs of the reverberation end time stored in the storage unit 25.

Then, the determination unit 23 determines that the difference between the natural frequency 55000 Hz of the microphone 11 stored in the storage unit 25 and the reverberation frequency 54950 Hz acquired by the acquisition unit 22 is within ±0.1% of the natural frequency 55000 Hz of the microphone 11 as the threshold. Accordingly, the detection system 1 detects that there is a short-distance object.

On the other hand, in a case where the determination unit 23 determines that the reverberation end time is shorter than the threshold, processing similar to the processing described in the first embodiment can be performed.

### 2-4. Detection of Adhesion of Foreign Matter

Next, detection of foreign matter adhesion according to the embodiment will be described. In the following example, the detection system 1 is mounted on a vehicle, and the detection system 1 detects adhesion of foreign matter to the ultrasonic sensor 10.

First, the transmission control unit 21 transmits an electric signal for transmitting an ultrasonic wave to the microphone 11 via the transmission unit 12. Next, the microphone 11 receives an electric signal and transmits an ultrasonic wave.

Next, the microphone 11 receives reverberation generated when an ultrasonic wave is transmitted and transmits the reverberation to the reception unit 13. Next, the reception unit 13 converts reverberation generated when an ultrasonic wave is transmitted into an electric signal. Next, the transmission/reception signal processing unit 14d receives the electrical signal from the transmission unit 12 and the reception unit 13, and processes the electrical signal so that the reverberation time measurement unit 14b and the reverberation frequency measurement unit 14c can handle the electrical signal. In this way, the reverberation time measurement unit 14b receives the electrical signal processed by the transmission/reception signal processing unit 14d and measures the reverberation end time. Furthermore, the reverberation frequency measurement unit 14c receives the electrical signal processed by the transmission/reception signal processing unit 14d and measures the reverberation frequency.

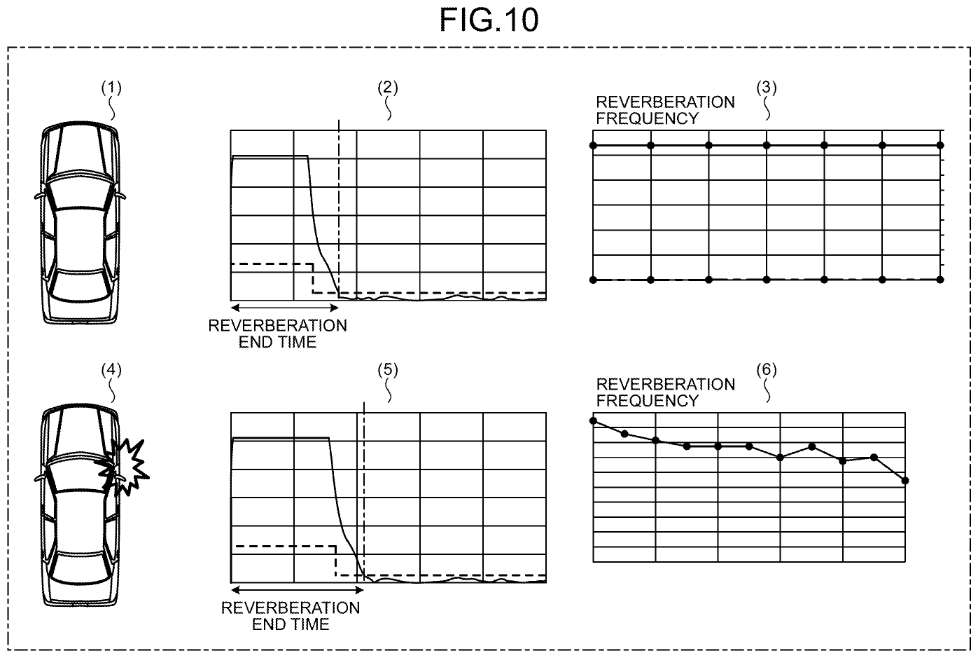

At this time, as illustrated in (1) of FIG. 10, in a case where no foreign matter adheres to the ultrasonic sensor 10 of the vehicle on which the detection system 1 is mounted, the reverberation end time is not affected by the foreign matter adhesion as illustrated in (2) of FIG. 10. On the other hand, as illustrated in (4) of FIG. 10, in a case where a foreign matter adheres to the ultrasonic sensor 10 of the vehicle on which the detection system 1 is mounted, as illustrated in (5) of FIG. 10, the reverberation end time becomes longer due to the influence of the adhesion of the foreign matter to the ultrasonic sensor 10.

Furthermore, as illustrated in (1) of FIG. 10, in a case where no foreign matter adheres to the ultrasonic sensor 10 of the vehicle on which the detection system 1 is mounted, the reverberation frequency hardly fluctuates with respect to the natural frequency of the microphone 11 as illustrated in (3) of FIG. 10. On the other hand, as illustrated in (4) of FIG. 10, in a case where a foreign matter adheres to the ultrasonic sensor 10 of the vehicle on which the detection system 1 is mounted, as illustrated in (6) of FIG. 10, the reverberation frequency fluctuates with respect to the natural frequency of the microphone 11 due to the influence of the adhesion of the foreign matter to the ultrasonic sensor 10.

Next, the acquisition unit 22 acquires the reverberation end time from the reverberation time measurement unit 14b and the reverberation frequency from the reverberation frequency measurement unit 14c. Next, the determination unit 23 makes a determination based on the reverberation end time and the reverberation frequency acquired by the acquisition unit 22. As a specific example, a case where the acquisition unit 22 acquires “2100 μs” as the reverberation end time and “54000 Hz” as the reverberation frequency, and the natural frequency of the microphone 11 is “55000 Hz” will be described. First, the determination unit 23 determines that the reverberation end time 2100 μs acquired by the acquisition unit 22 is longer than the threshold 1700 μs of the reverberation end time stored in the storage unit 25.

Then, the determination unit 23 determines that the difference between the natural frequency 55000 Hz of the microphone 11 stored in the storage unit 25 and the reverberation frequency 54000 Hz acquired by the acquisition unit 22 is not within ±0.1% of the natural frequency 55000 Hz of the microphone 11 as the threshold. As a result, the detection system 1 detects that a foreign matter is attached to the ultrasonic sensor 10.

### 2-5. Flowchart

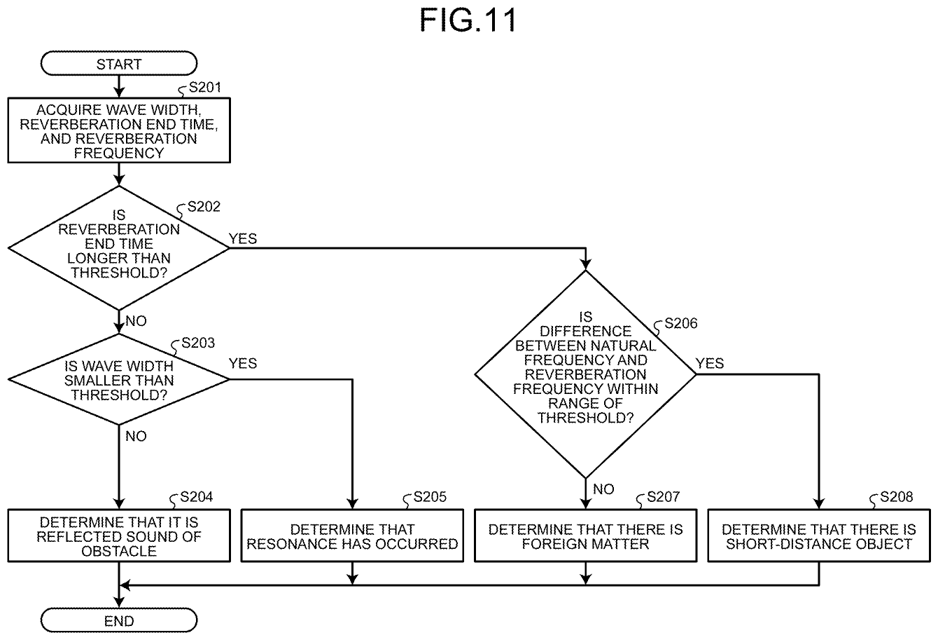

Next, a flow of detection processing executed by the detection system 1 configured as described above will be described with reference to FIG. 11. Note that the following steps can be executed in different orders, and there may be omitted processing.

First, the acquisition unit 22 acquires a wave width, a reverberation end time, and a reverberation frequency of an ultrasonic wave (step S201). For example, the acquisition unit 22 acquires the wave width, the reverberation end time, and the reverberation frequency of the ultrasonic wave from the measurement unit 14.

Next, the determination unit 23 determines whether the reverberation end time is longer than a threshold (step S202). At this time, in a case where the reverberation end time is shorter than the threshold (step S202 “NO”), subsequently, the determination unit 23 determines whether the wave width is smaller than the threshold (step S203). Here, in a case where the wave width is not smaller than the threshold (step S202 “NO”), the determination unit 23 determines that it is the reflected sound of the obstacle (step S204). On the other hand, in a case where the wave width is smaller than the threshold (“YES” in step S202), the determination unit 23 determines that the resonance has occurred (step S205).

On the other hand, in a case where the determination unit 23 determines that the reverberation end time is longer than the threshold (step S202 “YES”), subsequently, the determination unit 23 determines whether the reverberation frequency is within the range of the threshold (step S206). Here, in a case where the reverberation frequency is not within the range of the threshold (step S206 “NO”), the determination unit 23 determines that a foreign matter is attached to the ultrasonic sensor 10 (step S207).

On the other hand, in a case where the reverberation frequency is within the range of the threshold (step S206 “YES”), the determination unit 23 determines that there is a short-distance object in the vicinity of the ultrasonic sensor 10 (step S208).

### 2-6. Effects

As described above, the acquisition unit 22 in the control device 20 according to the embodiment further acquires the reverberation end time and the reverberation frequency of the ultrasonic wave transmitted by the ultrasonic sensor 10, and the determination unit 23 determines whether or not the reverberation end time of the ultrasonic wave acquired by the acquisition unit 22 is longer than a predetermined threshold, and, when determining that the reverberation end time is longer than the predetermined threshold, determines whether a foreign matter is attached to the ultrasonic sensor 10 or an object exists in the vicinity of the ultrasonic sensor 10 based on the predetermined natural frequency and the reverberation frequency.

As a result, the control device 20 according to the embodiment can acquire the wave width, the reverberation end time, and the reverberation frequency of the ultrasonic wave, correctly discriminate the foreign matter adhesion and the short-distance object based on the reverberation end time and the reverberation frequency of the ultrasonic wave, and then correctly discriminate the unnecessary resonance of the ultrasonic sensor 10 and the reflected sound from the obstacle.

Furthermore, the determination unit 23 in the control device 20 according to the embodiment further determines whether or not the difference between the natural frequency and the reverberation frequency is within a predetermined range, determines that an object is present in the vicinity of the ultrasonic sensor in a case where the difference is within the predetermined range, and determines that a foreign matter is attached to the ultrasonic sensor in a case where the difference exceeds the predetermined range.

As a result, the control device 20 according to the embodiment can acquire the wave width, the reverberation end time, and the reverberation frequency of the ultrasonic wave, correctly discriminate the foreign matter adhesion and the short-distance object by using the difference between the reverberation end time and the reverberation frequency of the ultrasonic wave, and then correctly discriminate the unnecessary resonance of the ultrasonic sensor 10 and the reflected sound from the obstacle.

### 3. Hardware Configuration

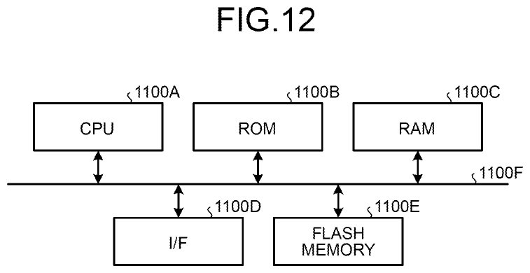

Next, a hardware configuration of the control device 20 will be described with reference to FIG. 12. As illustrated in FIG. 12, the control device 20 has a hardware configuration using a normal computer in which a central processing unit (CPU) 1100A, a read only memory (ROM) 1100B, a random access memory (RAM) 1100C, an interface (I/F) 1100D, a flash memory 1100E, and the like are connected to each other by a bus 1100F.

The CPU 1100A is an arithmetic device that controls the entire control device 20. Note that the CPU 1100A is an example of a processor, and another processor or a processing circuit may be provided instead of the CPU 1100A. The ROM 1100B stores programs and the like for realizing various processes by the CPU 1100A. The RAM 1100C is, for example, a main storage device of the control device 20, and stores data used for various processes by the CPU 1100A. The I/F 1100D is an interface for transmitting and receiving data. In addition, the flash memory 1100E is an example of a writable nonvolatile storage medium. The ROM 1100B, the RAM 1100C, and the flash memory 11E are also referred to as storage units. Note that the control device 20 may include another storage device such as a hard disk drive (HDD) instead of the flash memory 1100E or in addition to the flash memory 1100E.

### 4. Others

Although the detection system and the like according to one or more aspects have been described above based on the embodiments, the present disclosure is not limited to the embodiments. The present disclosure may also include embodiments obtained by applying various modifications conceived by those skilled in the art to the present embodiments and embodiments constructed by combining components in different embodiments without departing from the spirit of the present disclosure.

The order in which each step in the flowchart is executed is for the purpose of specifically describing the present disclosure, and may be an order other than the above. In addition, some of the steps may be executed simultaneously (in parallel) with other steps, or some of the steps may not be executed.

Furthermore, the division of the functional blocks in the block diagram is an example, and a plurality of functional blocks may be realized as one functional block, one functional block may be divided into a plurality of functional blocks, or some functions may be transferred to another functional block. In addition, functions of a plurality of functional blocks having similar functions may be processed in parallel or in a time division manner by single hardware or software.

Note that, in the above-described embodiments, the notation “ . . . unit” used for each component may be replaced with other notation such as “ . . . circuitry”, “ . . . assembly”, “ . . . device”, “ . . . part”, or “ . . . module”.

The disclosed device can use the wave width from the ultrasonic sensor to correctly discriminate between unnecessary resonance of the ultrasonic sensor and an obstacle.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

What is claimed is:

1. A control device comprising:
an acquisition circuit that acquires a wave width of an ultrasonic wave transmitted by an ultrasonic sensor; and
a determination circuit that determines that a resonance has occurred when the wave width of the ultrasonic wave acquired by the acquisition circuit is smaller than a threshold.

2. The control device according to claim 1, wherein the acquisition circuit acquires the wave width of the ultrasonic wave transmitted by the ultrasonic sensor provided in front of, behind, or on a side surface of a vehicle.

3. The control device according to claim 1, wherein the threshold is a value of ⅖ of a reverberation end time.

4. The control device according to claim 1, wherein
the acquisition circuit further acquires a reverberation end time and a reverberation frequency of the ultrasonic wave transmitted by the ultrasonic sensor, and
the determination circuit further determines whether or not the reverberation end time of the ultrasonic wave acquired by the acquisition circuit is longer than a predetermined threshold, and, when determining that the reverberation end time is longer than the predetermined threshold, determines whether a foreign matter is attached to the ultrasonic sensor or an object is present in a vicinity of the ultrasonic sensor, based on a predetermined natural frequency and the reverberation frequency.

5. The control device according to claim 4, wherein
the determination circuit further determines whether or not a difference between the natural frequency and the reverberation frequency is within a predetermined range, determines that the object is present in the vicinity of the ultrasonic sensor when the difference is within the predetermined range, and determines that the foreign matter is attached to the ultrasonic sensor when the difference exceeds the predetermined range.

6. A control method executed by a control device, comprising:
acquiring a wave width of an ultrasonic wave transmitted by an ultrasonic sensor; and
determining whether or not the wave width of the ultrasonic wave acquired is larger than a threshold, determining that an object is present when determining that the wave width is larger than the threshold, and determining that a resonance has occurred when determining that the wave width is equal to or smaller than the threshold.

7. The control method according to claim 6, wherein the ultrasonic waves are transmitted by the ultrasonic sensors provided in front, behind, or on a side surface of a vehicle.

8. The control method according to claim 6, wherein
the threshold is a value of ⅖ of a reverberation end time.

9. The control method according to claim 6, further comprising:
acquiring a reverberation end time and a reverberation frequency of the ultrasonic wave transmitted by the ultrasonic sensor;
determining whether or not the reverberation end time of the ultrasonic wave acquired by the acquisition circuit is longer than a predetermined threshold, and,
determining whether a foreign matter is attached to the ultrasonic sensor or an object is present in a vicinity of the ultrasonic sensor, based on a predetermined natural frequency and the reverberation frequency, when determining that the reverberation end time is longer than the predetermined threshold.

10. The control method according to claim 6, further comprising:
acquiring a reverberation end time and a reverberation frequency of the ultrasonic wave transmitted by the ultrasonic sensor;
determining whether or not a difference between a predetermined natural frequency and the reverberation frequency is within a predetermined range;
determining that the object is present in the vicinity of the ultrasonic sensor when the difference is within the predetermined range, and
determining that the foreign matter is attached to the ultrasonic sensor when the difference exceeds the predetermined range.

11. A non-transitory computer readable medium on which programmed instructions are stored, wherein the programmed instructions, when executed by a computer, cause the computer to perform:
acquiring a wave width of an ultrasonic wave transmitted by an ultrasonic sensor; and
determining whether or not the wave width of the ultrasonic wave acquired is larger than a threshold, determining that an object is present when determining that the wave width is larger than the threshold, and determining that a resonance has occurred when determining that the wave width is equal to or smaller than the threshold.
